(19) United States
(12) Patent Application Publication
(10) Pub. No.: US 2005/0054813 A1
(43) Pub. Date: Mar. 10, 2005

(54) Biodegradable polyesters obtained by reactive extrusion

(75) Inventors: Catia Bastioli, Novara (IT); Giandomenico Cella, Novara (IT); Gianfranco Deltredici, Sesto Calende (IT); Tiziana Milizia, Novara (IT)

Correspondence Address: CONNOLLY BOVE LODGE & HUTZ LLP, SUITE 800, 1990 M STREET NW, WASHINGTON, DC, 20036-3425, US

(73) Assignee: Novamont S.p.A., Novara (IT)

(21) Appl. No.: 10/968,190

(22) Filed: Oct. 20, 2004

Related U.S. Application Data
(63) Continuation of application No. PCT/EP03/04197, filed on Apr. 17, 2003.

(30) Foreign Application Priority Data
Apr. 22, 2002 (IT) MI2002A000865

(51) Int. Cl. C08G 63/02

(52) U.S. Cl. 528/272

(57) ABSTRACT

A composition of one or more biodegradable aliphatic and/or aliphatic-aromatic thermoplastic polyesters obtained by reactive extrusion of the polyesters with organic peroxides.

The present invention relates to a composition of one or more biodegradable aliphatic and/or aliphatic-aromatic thermoplastic polyesters obtained by reactive extrusion of the polyesters with organic peroxides.

One of the main problems associated to the use of biodegradable polyesters in the production of articles is the difficulty of obtaining polymers with molecular weights high enough to be used with the various known transformation technologies (such as for instance film blowing). Compatibility of biodegradable polyesters with other polymers is also a problem.

Organic peroxides are chemical specialties used in the polymer field especially as initiators for the polymerization or copolymerization of vinyl monomers (for instance, PVC, LDPE, polystyrene), as reinforcement agents for elastomers and resins as well as cross-linking agents for ethylene/propylene and synthetic rubbers or silicones.

In the sector of biodegradable polymers, EP-0 989 159 (JSP Corporation) discloses the use of organic peroxides as cross-linking agents of non-cross-linked aliphatic polyesters to obtain resins with a high gel fraction that allow the production of foams having improved properties. In particular, peroxides are added to beads of non cross-linked aliphatic polyesters after their production to obtain cross-linked resin beads that are subsequently expanded.

EP-0 737 219 (Neste Oy) discloses instead the use of organic peroxides as stabilizers of polyhydroxy acids (namely polylactic acid and polycaprolactone) in order to reduce the scission of polymer chains (i.e. their molecular weight reduction) during polymer processing. U.S. Pat. No. 5,500,465 discloses the use of peroxides as cross-linking initiators for biodegradable aliphatic polyesters or copolyesters of the polyhydroxy acid type, used in blend with starch or polysaccharide compounds. This patent relates in particular to blends containing only natural starches dried to a water content of less than 1% (wt) and mixed with a biodegradable polyester in the presence of a plasticizer other than water.

The prior art does not disclose biodegradable polyesters of the dicarboxyliclic acid/diol type extrusion-upgraded with organic peroxides with the aim of rendering them more suitable for film processing without significant increase of cross-linking phenomena.

On the contrary, according to the present invention, the increase of the molecular weight occurs without significant cross-linking phenomena which would lead to gel formation rendering the polyesters unsuitable for various processing types, such as for instance film blowing.

The present invention relates to a composition of one or more biodegradable thermoplastic aliphatic and/or aliphatic-aromatic polyesters, of the dicarboxyliclic acid/diol type, obtained by reactive extrusion of polyesters with organic peroxides.

According to this invention it was surprisingly found that biodegradable thermoplastic polyesters, of the dicarboxylic acid/diol type, with high molecular weight can be obtained by addition of organic peroxides during their extrusion process. The increase in the molecular weight of biodegradable polyesters can be easily assessed by observing the increase in viscosity values following the processing of polyesters with peroxides.

In particular, in the composition according to the invention, the polyester is obtained through a reactive extrusion reaction at reaction temperatures higher by at least 20° C. than the melting temperature of the polyester, and such that the half lives T_{dim} of the peroxide are of less than 10 minutes.

The inherent viscosity of the polyester before the reactive extrusion is comprised between 0,5-1,5 dl/g, preferably 0,8-1,4 dl/g, whereas the inherent viscosity of the polyester after the reactive extrusion is comprised between 0,7-1,7 dl/g, preferably 0,9-1,5 dl/g.

Examples of dicarboxylic acids include oxalic acid, malonic acid, succinic acid, glutaric acid, adipic acid, pimelic acid, suberic acid, azelaic acid, sebacic acid, undecandioic acid, dodecandioic acid and brassylic acid.

Examples of diols include 1,2-ethandiol, 1,2-propandiol, 1,3-propandiol, 1,4-butandiol, 1,5-pentandiol, 1,6-hexandiol, 1,7-heptandiol, 1,8-octandiol, 1,9-nonandiol, 1,10-decandiol, 1,11-undecandiol, 1,12-dodecandiol, 1,13-tridecandiol, 1,4-cyclohexandimethanol, neopentyl-glycol, 2-methyl-1,3-propandiol, dianhydrosorbitol, dianhydromannitol, dianhydroiditol, cyclohexandiol, cyclohexanmethandiol.

In addition to the dicarboxylic acid and the diol, the biodegradable polyester according to the invention may advantageously comprise as a starting monomer also a natural or synthetic unsaturated acid. Its content is within the range of 0,1 to 20%, preferably 0,2 to 10%, and more preferably 0,3 to 7% in moles with respect to the total content of the acids in the composition.

Examples of unsaturated acids of synthetic origin are malonic acid, fumaric acid, vinyl acetate, acrylic acids, methacrylic acids, hydroxyalkylacrylates and hydroxyalkylmethacrylates.

Examples of unsaturated acids of natural origin are monounsaturated hydroxyacids, such as ricinoleic acid and lesquerolic acid, mono-, or polyunsaturated monocarboxylic acids, such as oleic, erucic, linoleic, linolenic and itaconic acid. The unsaturated acids of natural origin may be used either in the pure form or mixed with other fatty acids either saturated or unsaturated. In particular they may be used as blends obtained from saponification or transesterification of the vegetable oils which they originate from. For instance, ricinoleic acid, in the form of methylricinoleate, may be used in a more or less pure form obtained through a transesterification reaction of castor oil with methanol, and subsequent removal of glycerin (a byproduct of the reaction) and excess methanol.

Advantageously, the biodegradable polyester according to the invention may be functionalized in particular by grafting molecules with unsaturated moieties.

Advantageously, the biodegradable polyester according to the invention may contain as a starting monomer also up to 50% moles—based on the content of dicarboxylic acid and other possible acids included in the chain—of a polyfunctional aromatic compound, such as phthalic acids, in particular terephthalic acid, bisphenol A, hydroquinone, and the like.

The polyester according to the invention may include, in addition to the base monomers, at least a hydroxy acid in an amount in the range from 0 to 49%, preferably 0 to 30% moles based on the moles of the aliphatic dicarboxylic acid. Examples of suitable hydroxy acids are glycolic acid, hydroxybutyric acid, hydroxycaproic acid, hydroxyvaleric acid, 7-hydroxyheptanoic acid, 8-hydroxycaproic acid, 9-hydroxynonanoic acid and lactic acid. In order to obtain branched products, in the preparation process of the copolyester according to the invention, one or more polyfunctional molecules may be advantageously be added in an amount from 0.1 to 3% moles based on the amount of dicarboxylic acid and unsaturated acid of natural origin (as well as of the possible hydroxy acids and phthalic acids). Examples of these molecules include glycerol, pentaerythritol, trimethylolpropane, citric acid, densipolic acid, auripolic acid, epoxydized soybean oil and castor oil.

Besides, the copolymer according to the invention may be obtained or used in blend with polyesters the same type, both random and block, polyesters—or with other polyesters, even of the polyhydroxyacid type, (also obtained by fermentation) or synthesized polymers other than polyesters, such as, for instance, polyamides, polycarbonates, polyolefins, polyurethanes; it may also be obtained or used in blend with polymers of natural origin such as starch, cellulose, chitosan, alginates or natural rubber. In such case the peroxide may compatibilize the different polymers in the blend leading to the formation of bonds between the different polymers chains.

In case of blend with starch, the mixing of the components should take place in the presence of water, and the latter may be the water naturally contained in the starch or also water added to act as a plasticizer of the starch composition. Starches and celluloses may be modified and among them, it is possible to mention, for instance, starch or cellulose esters with a substitution degree within the range of 0.2 to 2.5, hydroxypropylated starches, and starches modified with fatty chains. Starch may also be used either in the destructurized or the gelatinized form.

Organic peroxides used in the production of biodegradable polyesters according to the invention include diacyl peroxides, peroxyesters, dialkyl peroxides, hydroxyperoxides, peroxy ketals and peroxy dicarbonates. Diacyl peroxides and dialkyl peroxides are preferred. Examples of such peroxides include, for instance, benzoyl peroxide, lauroyl peroxide, isononanoyl peroxide, dicumyl peroxide, di-(tert-butilperoxyisopropyl)benzene, tert-butyl peroxyde, 2,5-dimethyl-2,5-di-(tert-butyl)peroxy hexane.

Organic peroxides are added in an amount ranging from 0,02 to 1,5 wt %, preferably from 0,03 to 1,0 wt %, and more preferably from 0,04 to 0,6 wt % based on the amount of polyester (plus the other polymers in case of blend). Particularly for films and sheets the preferred range is 0,02-0,7 wt %, preferably 0,03-0,5 wt % whereas for foamed products the preferred range is 0,1-1,5 wt %, preferably 0,2-1,0 wt %.

The skilled person will be able to easily identify the actual amount of peroxide necessary with respect to the nature of the polymer, so as to obtain the polymer with the gel percentage according to the invention. For instance, in case of polymers modified through the introduction of chain unsaturation, it is convenient to operate with lower amount of peroxides with respect to the amount necessary for the same type of saturated polyesters.

Organic peroxides are, as known, characterized in that they have a limited stability to heating: they are likely to decompose at more or less high temperatures, and often in a violent and explosive manner. An important characteristic to know the behavior of organic peroxides is therefore their half lives T_{dim}, i.e. the time within which, at a given temperature t, half of the peroxide is reacted. The dependence of the half life T_{dim} from temperature t is of an exponential type:
T_{dim}=ae^{-bt}(with a and b=constants)
this means that, for a given peroxide, the higher the temperature, the lower the T_{dim}. In the composition according to the present invention, the polyester is obtained through a reactive extrusion reaction at reaction temperatures at least 20° C. higher than the melting temperature of the polyester and such that the half lives T_{dim} of the peroxide are of less that 10 minutes, preferably less than 5 minutes and more preferably less than 3 minutes.

In the composition according to the present invention, the polyester is obtained with a gel fraction lower than 4,5% (w/w) with respect to the polyester, preferably lower than 3% and still more preferably lower than 1%.

The gel fraction according to the present invention is defined by placing a sample of polyester (X¹) in chloroform under reflux for 8 hours, filtering the mixture on a sieve and weighing the weight of the material that remains on the filtering grid (X²). The gel fraction was determined as the ratio of the material so obtained with respect to the weight of the sample (X²/X¹)×100. The polyesters according to the invention are suitable to be used—by suitably modulating the relevant molecular weight—in many practical applications such as films, injection molding and extrusion coating products, fibers, foams, thermo-molded products, etc. In particular, the polyesters according to the invention are suitable for the production of:
films, either mono- or bidirectional, and multi-layer films with other polymeric materials;
films for agriculture such as mulching films;
bags and liners for organic waste collection;
mono- or multi-layer food packaging, such as for instance containers for milk, yogurt, meat, drinks, etc;
coatings obtained with the extrusion coating technique;
multi-layer laminates with layers from paper, plastics, aluminum, metalized films;
expanded and half-expanded products, including expanded blocks obtained from pre-expanded particles;
expanded sheets, thermoformed sheets and containers obtained therefrom for food packaging;
containers in general for fruits and vegetables;
composites with gelatinized, destructurized and/or complexed starch or with natural starch for use as filler;
fibers, fabrics and non-woven fabrics for the sanitary and hygiene sector.

Some non-limiting examples of the polyester according to the invention will follow.

### EXAMPLES

### Example 1

By polycondensation of sebacic acid and butanediol (molar ratio diol/dicarboxylic acid=1.05) and in the presence of isopropoxy Al the catalyst, a linear polybutylene sebacate was obtained. The polybutylene sebacate production process was carried out according to the teaching of patent WO 00/55236.

The polymer was synthesized in a 251 steel reactor, provided with mechanical stirrer, an inlet for nitrogen flow, a condenser and a connection with a vacuum pump, starting from
6000 g sebacic acid (29,7 moles),
2807 g butane diol (31,2 moles),
6 g isopropoxy Al (corresponding to 3,0 10⁻² moles).

The temperature was gradually increased to 210° C. under vigorous agitation and nitrogen flow. The reaction was continued until 90% of the theoretical amount of light byproducts was distilled. The temperature was then increased to 240° C. and the system was set at a pressure of 0,6 mmHg. The reaction was carried on for 120 min. 7 kg of a polymer having an inherent viscosity 0,85 dl/g (0,2 g/dl solution in CHCl₃ at 25° C.), a MFR (150° C.; 2.16 kg) of 44 g/10 min and Tₘ=65° C. was obtained.

1 kg of the so obtained polymer was reacted with 4 g (0,4 pph) of 2,5-dimetyl-2,5-di(tert-butyl)peroxyhexane (Luperox 101) in a twin-screw extruder Haake Rheocord 90 with an extrusion equipment Theomex TW-100 whose main characteristics are:
Barrel: length 395 mm, diameter 20-32 mm
Feeding: forced cooling at 23° C.
Screws (intensive mix): conic, contrarotating, diameter 20-31 mm, length 331 mm
Head: length 80 mm, diameter 20 mm; nozzle: diameter 3 mm.

The process was carried out under the following conditions:
temperature profile; 23-90-170-170-170° C.
rotation speed of screw: 200 rpm; throughput: 1 kg/h.

The temperature profile shows that the temperature in the 1^{st} zone of the extruder (feeding zone) is lower than Tₘ of the polyester, and that in the following zone, while being higher, it is such that T_{dim} of the peroxide is higher than 10 min. This has the purpose of reaching working temperatures with a T_{dim} of the peroxide of less than 10 minutes only after a suitable mixing of the reactants.

The resulting product has inherent viscosity of 1,23 dl/g (in solution, 0,2 g/dl of CHCl₃ at 25° C.,) MFR (150° C.; 2.16 kg) of 1.4 g/10 min and melting point Tₘ=64° C.

The half life T_{dim} of 2,5-dimetyl-2,5-di(tert-butyl)peroxyhexane at 170° C. was of about 2,5 min. The T_{dim} was calculated on the basis of the data supplied by the peroxide producer (see Table I).

The product was then analyzed to determine the amount of gels. In particular, a sample of about 4 g (X¹) was placed in a container with 200 ml chloroform. The mix was then reflux-heated for 8 hours and vacuum-filtered with a filtering means having a 600 mesh sieve. The material that remained on the filtering net after the filtration treatment was then oven-dried at about 50° C. for 8 hours under reduced pressure. The weight of the thus obtained material (X²) has been determined. The gel fraction was determined as the ratio between the thus obtained material and the sample weight (X²)/(X¹)=0.5%.

### Example 2

The upgrading is carried out with linear polybutylene sebacate-co-ricinoleate obtained by polycondensation. The synthesis of the polymer was according to the process described in Example 1 with:
6000 g sebacic acid (29,7 moles)
2940 g butane diol (32,7 moles)
489.4 g methyl ricinoleate (1,6 moles)
9 g of monobutylstannoic acid (4,3-10-2 moles)

The temperature was gradually increased to 210° C. under vigorous agitation and nitrogen flow. The reaction was continued until 98% of the theoretical amount of light byproducts was distilled. The temperature was then increased to 240° C. and the system was set at a pressure of 1 mmHg. The reaction was carried on for 120 min. 7 kg of a polymer having an inherent viscosity of 0,92 dl/g and Tₘ=62° C. were obtained.

1 kg of polymer was reacted with 1 g (0,1 pph) of 2,5-dimetyl-2,5-di(tert-butyl) peroxyhexane (Luperox 101) in a Haake Rheocord extruder with the following conditions:
temperature profile; 23-90-170-170-170° C.
screw rotation speed: 200 rpm; throughput: 1 kg/h.

A product with inherent viscosity of 1.26 dl/g is obtained having a gel fraction, determined as in example 1, of 0.22%.

### Example 3

The upgrading is carried out on polybutylene sebacate-co-ricinoleate, branched with a trifunctional monomer, obtained by polycondensation. The synthesis of the polymer was realized according to the process described in Example 1 with:
6000 g sebacic acid (29,7 moles)
2940 g butane diol (32,7 moles)
1384 g methyl ricinoleate (4,43 moles)
25.1 g glycerol (0.27 moles)
9 g of monobutylstannoic acid (Fascat 4100—corresponding to 4,3·10⁻² moles).

The temperature was gradually increased to 210° C. under vigorous agitation and nitrogen flow. The reaction was carried on until 95% of the theoretical amount of light byproducts was distilled. The temperature was then increased to 240° C. and a pressure of 0,6 mmHg was applied to the system. The reaction was continued for 300 min. 7 kg of a polymer having an inherent viscosity of 1,15 dl/g were obtained.

1 kg of polymer was reacted with 2 g (0,2 pph) of dibenzoyl peroxide (Aldrich) in a Haake Rheocord extruder in the following conditions:
temperature profile: 100-150-150-150° C.
screw rotation speed: 150 rpm; throughput: 3 kg/h

A product is obtained having inherent viscosity of 1,35 dl/g and a gel fraction=0.5%.

### Example 4

6000 g sebacic acid (29,7 moles);
2940 g butane diol (32,7 moles);
9 g Fascat 4100 (4,3,·10⁻² moles)
   were reacted in the reactor of Example 1.

The temperature was gradually increased to 210° C. uner vigorous agitation and nitrogen flow. The reaction was continued until 95% of the theoretical amount of light byproducts (780 ml) was distilled. The temperature was then increased to 240° C. and the system was set at a pressure of 1,0 mmHg. The reaction was continued for 120 min. 7 kg of a polybutylene sebacate having inherent viscosity of 0,84 dl/g were obtained. The polymer was then filmed in a Haake Rheocord.

In the reactor of Example 1:
5050 g sebacic acid (25.0 moles);
2700 g neopentyl glycole (26.0 moles);
8 g Fascat 4100 (3.8 10⁻² moles)
   were then added.

The temperature was gradually increased to 210° C. under vigorous agitation and nitrogen flow. The reaction was continued until 87% of the theoretical amount of light byproducts (780 ml) was distilled. The temperature was then increased to 240° C. and the system was set at a pressure of 0,2 mmHg. The reaction was continued for 200 minutes. The product (polyneopentylensebacate) is an amorphous polymer at room temperature, showing no melting peak with DSC, and with an inherent viscosity of 0,87 dl/g. Being amorphous, the product cannot be filmed.

240 g polybutylene sebacate and 160 g polyneopentylensebacate obtained as described above were reacted in an extruder with 1,2 g (0,3 pph) 2,5-dimetyl-2,5-di(tert-butyl)peroxyhexane (Luperox 101-Atofina) in the following conditions:
temperature profile: 23, 90, 170, 170, 170° C.
screw rotation speed: 200 rpm; throughput: 1,2 kg/h.

A polymer is obtained having a viscosity of 1,29 dl/g and a gel fraction=0.12%. The Haake filmed product provides the following results:

| | Longitudinal | Transversal Direction |
|---|---|---|
| | Direction (N/mm) | (N/mm) |
| Polybutylene sebacate | 3 | 20 |
| Example 4 | 10 | 30 |

### Example 5

700 g of the polymer of Example 2,
300 g natural rubber CV 60,
3 g 2,5-dimetyl-2,5-di(tert-butyl)peroxy hexane (Luperox 101—Atofina) (0,3 pph)
temperature profile: 23-100-100-100-100° C.
screw rotation speed: 200 rpm; throughput: 1 kg/h
   were extruded in a Haake Rheocord extruder.

The thus obtained product was then reacted in an extruder at a higher temperature:
temperature profile: 23-90-170-170-170° C.
screw rotation speed: 200 rpm; throughput: 1 kg/h.

A film produced in a Hake Rheocord extruder is obtained. The Elmendorf tearing resistance of the film compared with that of the film of the polymer according to Example 2 is shown in the table. The values show that a significant improvement in the tearing resistance in the longitudinal direction and a balancing of this property in both directions was obtained.

| | Long. Direction | Transv. Direction |
|---|---|---|
| | (N/mm) | (N/mm) |
| Ex. 2 | 5 | 23 |
| Ex. 5 | 16 | 25 |

TABLE 1
Half lives T_{dim} of the peroxides used

| | T_{dim} | 10 h | 1 h | 1 min |
|---|---|---|---|---|
| 1 | 2,5-dimethyl-2.5-di(tert-butyl)peroxy | 119 | 138 | 177 |
| | hexane | | | |
| 2 | Di(tert-butylperoxy-isopropyl)benzene | 121 | 142 | 185 |
| 3 | Lauroyl peroxide | 62 | 80 | 120 |
| 4 | Benzoyl peroxide | 73 | 92 | 131 |

T_{dim} of 10 min correspond to the following temperatures:
(1) 157° C.; (2) 161° C.; (3) 98° C.; (4) 111° C.

1. A composition of one or more biodegradable aliphatic and/or aliphatic-aromatic thermoplastic polyesters of the dicarboxylic acid/diol type, obtained by reactive extrusion of the polyesters with organic peroxides said composition having a gel fraction lower than 4,5% (w/w) with respect to the polyester.

2. The composition according to claim 1, wherein the polyester is obtained by reactive extrusion at reaction temperatures at least 20° C. higher than the polyester melting temperature and such that the half lives T_{dim} of the peroxide are less than 10 minutes.

3. The composition according to claim 2, wherein the dicarboxylic acid is selected from the group comprising oxalic acid, malonic acid, succinic acid, glutaric acid, adipic acid, pimelic acid, suberic acid, azelaic acid, sebacic acid, undecandioic acid, dodecandioic acid and brassylic acid.

4. The composition according to claim 3, wherein the diol is selected from the group comprising 1,2-ethandiol, 1,2-propandiol, 1,3-propandiol, 1,4-butandiol, 1,5-pentandiol, 1,6-hexandiol, 1,7-heptandiol, 1,8-octandiol, 1,9-nonandiol, 1,10-decandiol, 1,11-undecandiol, 1,12-dodecandiol, 1, 13-tridecandiol, 1,4-cyclohexandimethanol, neopentylglycol, 2-methyl-1,3-propandiol, dianhydrosorbitol, dianhydromannitol, dianhydroiditol, cyclohexandiol, cyclohexanmethandiol.

5. The composition according to, claim 1, wherein the starting monomer also comprises an unsaturated acid of natural or synthetic origin in an amount within the range of 0,11 to 20% in moles with respect to the total content of the acids in the composition.

6. The biodegradable composition according to claim 1, wherein the starting monomer further comprises up to 50% moles, based on the total amount of dicarboxylic acid/diol, of a polyfunctional aromatic compound.

7. The composition according to claim 1, comprising one or more polyfunctional molecules in amounts within the range of 0.11 to 3% moles based on dicarboxylic acid, said molecules being selected from glycerol, pentaerythritol, trimethylolpropane, citric acid, densipolic acid, auripolic acid, epoxydized soybean oil and castor oil.

8. The composition according to claim 1, comprising at least one hydroxy acid in an amount within the range of 0.1 to 49% moles based on the moles of dicarboxylic acid, said hydroxy acid being selected from the group comprising glycolic acid, hydroxybutyric acid, hydroxycaproic acid, hydroxyvaleric acid, 7-hydroxyheptanoic acid, 8-hydroxycaproic acid, 9-hydroxynonanoic acid and lactic acid.

9. The composition according to claim 1, in a blend with polyesters of the same type, random or block, or with other polyesters, even of the polyhydroxyacid type (also obtained by fermentation), or with synthetic polymers other than the polyesters, or with polymers of natural origin selected from the group comprising starch, cellulose, chitosan, alginates an natural rubber.

10. The composition according to claim 1 wherein starch and cellulose are modified and/or starch is present in a destructurized o gelatinized form.

11. The composition according to claim 1 wherein mixing with starch takes place in the presence of water, naturally contained in starch or added as a plasticizer of the starch composition.

12. The composition according to claim 1, wherein the organic peroxides are selected from the group comprising diacyl peroxides, peroxy esters, dialkyl peroxides, hydroxyperoxides, peroxy ketals and peroxy dicarbonates.

13. The composition according to claim 12, wherein diacyl peroxides and dialkyl peroxides are selected from the group comprising benzoyl peroxide, lauroyl peroxide, isonanoyl peroxide, dicumyl peroxide, di-(tert-butylperoxyisopropyl)benzene, tert-butylperoxide, 2,5-dimetyl-2,5-di(tert-butyl)peroxyhexane.

14. A process of producing a composition of one or more biodegradable aliphatic and/or aliphatic-aromatic thermoplastic polyesters of the dicarboxylic acid/diol type, obtained by reactive extrusion of the polyesters with organic peroxides at reaction temperatures at least 20° C. higher than the melting temperature of the polyesters, and such that the half lives T_{dim} of the peroxide are less than 10 minutes.

15. Use of the composition of one or more biodegradable aliphatic and/or aliphatic-aromatic thermoplastic polyesters according to claim 1 for the production of:
films, either mono- or bidirectional, and multi-layer films with other polymeric materials;
films for agriculture such as mulching films;
bags and liners for organic waste collection;
mono- or multi-layer food packaging, such as for instance containers for milk, yogurt, meat, drinks, etc;
coatings obtained with the extrusion coating technique;
multi-layer laminates with layers from paper, plastics, aluminum, metalized films;
expanded and half-expanded products, including expanded blocks from pre-expanded particles;
expanded sheets, thermoformed sheets and containers obtained therefrom for food packaging;
containers in general for fruits and vegetables;
composites with gelatinized, destructurized and/or complexed starch or natural starch for use as filler;
fibers, fabrics and non-woven fabrics for the sanitary and hygiene sector.

16. Shaped articles obtainable from the claim 1.

17. Shaped articles according to claim 16, wherein said articles are selected from monodirectional films, bidirectional films, multi-layer films with other polymeric materials, mulching films, coatings obtained from extrusion coating technique.

18. Shaped articles according to claim 16, wherein said articles are selected from bags or liners for organic waste collection.

19. Shaped articles according to claim 16, wherein said articles are mono or multi-layer food containers selected from milk containers, yogurt containers, meat containers, drinks containers, fruit containers, vegetables containers.

20. Shaped articles according to claim 16, wherein said articles are multi-layer laminates comprising a layer of material selected from paper, plastics, aluminum, metallized film.

21. Shaped articles according to claim 16, wherein said articles are selected from expanded products, half-expanded products, expanded blocks from pre-expanded particles, expanded sheets, thermoformed sheets, containers for food packaging made of expanded sheets or thermoformed sheets.

22. Shaped articles according to claim 16, wherein said articles are selected from composites with gelatinized, destructured and/or complexed starch or natural starch as filler.

23. Shaped articles according to claim 16, wherein said articles are selected from fibers, fabrics, nonwoven fabrics for the sanitary or hygiene sector.

24. The composition according to claim 1, wherein said composition has a gel fraction lower than 3% (w/w) with respect to the polyester.

25. The composition according to claim 1, wherein said composition has a gel fraction lower than 1% (w/w) with respect to the polyester.

26. The composition according to claim 1, wherein the half lives T_{dim} of the peroxide are less than 5 minutes.

27. The composition according to claim 1, wherein the half lives T_{dim} of the peroxide are less than 3 minutes.

28. The composition according to claim 1, wherein the starting monomer also comprises an unsaturated acid of natural or synthetic origin in an amount within the range of 0.2 to 10% in moles with respect to the total content of the acids in the composition.

29. The composition according to claim 1, wherein wherein the starting monomer also comprises an unsaturated acid of natural or synthetic origin in an amount within the range of 0.3 to 7% in moles with respect to the total content of the acids in the composition.

30. The composition according to claim 1, which comprises at least one hydroxy acid in an amount within the range of 0 to 30% moles based on the moles of dicarboxylic acid.

31. The process according to claim 14, wherein the half lives T_{dim} of the peroxide are less than 5 minutes.

32. The process according to claim 14, wherein the half lives T_{dim} of the peroxide are less than 3 minutes.
